(19) United States
(12) Patent Application Publication
(10) Pub. No.: US 2011/0008761 A1
(43) Pub. Date: Jan. 13, 2011

(54) ON-DEMAND REAL TIME VIDEO TRAINING AND SELF ANALYSIS SYSTEM

(76) Inventors: SOUREN HAKOPIAN, VIENNA, VA (US); CLIVE B. WRIGHT, SILVER SPRING, MD (US); GARY W. EGERTON, SILVER SPRING, MD (US); GHASSEM SHARIFI, OAKTON, VA (US); SHANT A. BABAIAN, ALEXANDRIA, VA (US)

Correspondence Address: SOUREN HAKOPIAN, 8576 WELLINGTON ROAD, MANASSAS, VA, 20109, US

(21) Appl. No.: 12/831,928

(22) Filed: Jul. 7, 2010

Related U.S. Application Data
(60) Provisional application No. 61/223,612, filed on Jul. 7, 2009.

(51) Int. Cl. G09B 5/00

(52) U.S. Cl. 434/308

(57) ABSTRACT

The present invention relates generally to a On-Demand Video Training and Self Analysis System and Analysis System, for use in (but not limited to): sports action training such as: golf, tennis, baseball, softball, table tennis, cricket, fencing, martial arts, gymnastics, as well as other types of action related training activity where technique and form may need to be reviewed and corrected as it is occurring. More specifically it relates to a single or multi camera video recording system for recording and analyzing action related real time events at the source. The On-Demand Video Training and Self Analysis System is unique in that it combines the best features of Video Training Systems and Instant Replay Systems, into a single system which allows the user to immediately see and self analyze his performance and correct deficiencies on the spot, and see the results of that correction immediately.

### CROSS REFERENCE TO RELATED APPLICATIONS

This application claims the benefit of U.S. Provisional Application No. 61/223,612 filed on Jul. 7, 2009 which is hereby incorporated by reference.

### BACKGROUND OF THE INVENTION

Video Training Systems date back to the mid nineteen sixties and were used almost exclusively in sports training. These systems were used primarily to improve the user's technique by comparing the user to a recognized master. They typically included one or more cameras, multiple monitors, and in some cases mirrors, to allow the user to compare their performance to a reference image of a recognized master in the sport or technique.

Instant Replay Systems (also used in sports) are systems which provide slow motion replay of specific short duration events or plays of interest and is primarily used by officials in high level professional competition (such as NBA basketball or NFL football) for disputed call resolution.

The On-Demand Video Training and Self Analysis System described below is unique in that it combines the best features of Video Training Systems and Instant Replay Systems, into a single system which allows the user to immediately see and self analyze his performance and correct deficiencies on the spot, and see the results of that correction immediately.

### BRIEF SUMMARY OF THE INVENTION

The present invention relates generally to a On-Demand Video Training and Self Analysis System, for use in (but not limited to): sports action training such as: golf, tennis, baseball, softball, table tennis, cricket, fencing, martial arts, gymnastics, as well as other types of action related training activity where technique and form may need to be reviewed and corrected as it is occurring. More specifically it relates to a single or multi camera video recording system for recording and analyzing action related real time events at the source.

An object of this invention is to provide a single or multi-camera view and capture of the event of interest, by utilizing one or more cameras placed in strategic locations to capture the relevant angles of view best suited for the action being monitored. The cameras are connected to the main unit via a wired or wireless data link.

The main unit comprises a processing engine with recording and playback capability, and a video display appropriate for the ambient light and prevailing environmental conditions, removable media storage (USB FLASH drive, Memory Card, DVD, etc), and may include a means to upload files to a website for later analysis by the user.

One or more action events are recorded over a timed interval, with the capability of providing a means for the user to perform slow motion analysis on a specific action event or groups of events.

The system provides the user the means for immediate self analysis, with feedback of his performance via slow motion analysis from multiple angles, thereby allowing quick correction of flawed techniques. For example: if the user is a golfer on a driving range, who by using the slow motion self analysis capability of the system detects a flaw in his swing that is affecting his accuracy, he can immediately correct this flaw on the next swing, review the next swing to verify that it is actually corrected, and immediately see the resulting improved accuracy.

Video recording can be triggered automatically or manually by a device at or near the user, or by a device worn by the user, or by a remote device triggered, or by an internal system timer, or by voice activation.

The system can be either permanently mounted at a specific location in reasonably close proximity to the action event (such as in kiosk form), or it can be portable, where it can be taken to the specific location for temporary mounting for the duration of the event or training session, or completely handheld wireless device (for example: a tablet PC form factor).

One embodiment of the system may include a credit card payment processing module, or private brand card, or coin, or token processing module, to permit pay-per-use type services.

Another embodiment of the system may include single or multi-view playback where views from some or all the cameras in the system can be viewed simultaneously in real time or played back simultaneously in normal or slow motion to facilitate event analysis from multiple view points.

Another embodiment of the system may include adding removable file transfer medium such as a USB flash drive, or memory card.

Another embodiment of the system may include file transfer via a hardwired or wireless data network to the user, or to a website accessible by the user.

Another embodiment of the device may include automatically adding a reader software application to the removable file transfer medium to allow full functionality multi-view playback on the user's standard PC.

There has thus been outlined, rather broadly, some of the features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction or to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

### BRIEF DESCRIPTION OF THE DRAWINGS

FIG. 1 is a block diagram illustrating an example of an on-demand real time video training and self analysis system for practicing the present invention.

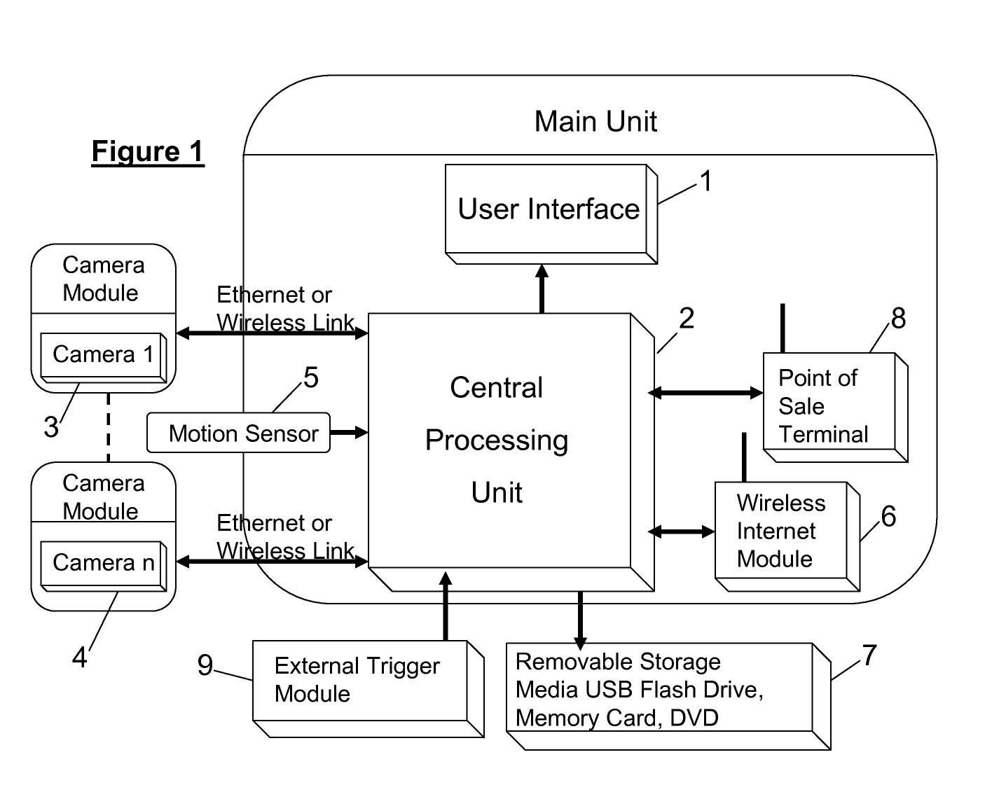

### DETAILED DESCRIPTION OF THE INVENTION

Overview: The present invention relates generally to a On-Demand Video Training and Self Analysis System and Analysis System, for use in (but not limited to): sports action training such as: golf, tennis, baseball, softball, table tennis, cricket, fencing, martial arts, gymnastics, as well as other types of action related training activity where technique and form may need to be reviewed and corrected as it is occurring. More specifically it relates to a single or multi camera video recording system for recording and analyzing action related real time events at the source.

The User Interface: The user interface to the system 1 comprises a display monitor, user input device (such as a touch screen, keypad, keyboard, mouse) or a voice activated module, The monitor and input device will be appropriate for the ambient light and environmental conditions and designed to survive under all normal use conditions.

The Central Processing Unit: The Central Processing Unit 2 could be either an embedded PC platform or an embedded microcontroller card dedicated to performing the video acquisition, recording, and video compression functions. This unit also manages video display presentation, optional advertising message sequencing, and related functions. This unit will be appropriately designed and environmentally protected to allow survival in all normal indoor or outdoor operating conditions.

The Camera Modules: The Camera Modules 3, 4 are environmentally sealed digital cameras linked via Ethernet or a wireless link back to the Central Processing Unit. The cameras are equipped with auto iris lenses to facilitate operation in varying ambient light conditions.

The Motion Sensor (Optional): The optional Motion Sensor Module 5 is used to detect the presence of a user and trigger appropriate screen content accordingly.

The Wireless Internet Module: The Wireless Internet Module 6 is essentially a wireless broadband modem that facilitates the uploading of recorded video files or usage data to a website for later use by the operator or customer.

The Removable Storage Media: The Removable Storage Media 7 may be either a USB FLASH drive, or a Memory Stick, or DVD media allows the user to take a copy of the files at the end of the session.

The Point of Sale Terminal: The Point of Sale Terminal 8 comprises a Wireless Credit Card Authorization system, which facilitates pay per use type services. In this type of service the system will only be allowed to run if a valid authorization is received for the users credit or debit card.

The External Trigger Module: The External Trigger Module 9 is an interface module for a variety of switches, infra red actuators, voice activation modules, and other devices that may be used to trigger recording, playback, or other actions in the system.

User Operation: During operation the user will first enable the system by using the point of sale terminal and swiping a credit card. Upon providing the appropriate amount of credit, the central processing unit will initiate the on-demand video training and analysis system by displaying video and a user interface for a timed interval of use, which allows the user to activate the features of the system such as recording, variable speed playback, frame by frame analysis, pause action, forward, rewind, email entry, and file storage and retrieval. The user session ends when the timed interval of use expires.

What is claimed is:

1. An on-demand video training and self analysis system, said system comprising:
a central processing unit,
at least one camera linked to said central processing unit,
a user interface linked to said central processing unit, and
at least one monitor linked to said central processing unit,
wherein said at least one cameras is capable of capturing moving images and said central processing unit is capable of storing said moving images as digital information and displaying said images on said monitor, and
wherein said user interface is capable of enabling a user to select at least one video playback speed to display said images on said at least one monitor, said at least one video speed comprises at least one or more of real time, normal speed, variable slow motion, pause, forward, rewind, and frame by frame analysis.

2. The on-demand video training and self analysis system of claim 1 further comprising a plurality of said cameras linked to the central processing unit.

3. The on-demand video training and self analysis system of claim 2, wherein said central processing unit is capable of simultaneously displaying images from more than one said cameras on said monitor.

4. The on-demand video training and self analysis system of claim 2 further comprising a plurality of monitors linked to the central processing unit.

5. The on-demand video training and self analysis system of claim 4, wherein said central processing unit is capable of simultaneously displaying images from said plurality of cameras on at least one of said plurality of monitors.

6. The on-demand video training and self analysis system of claim 1 further comprising a point of sale terminal linked to said central processing unit.

7. The on-demand video training and self analysis system of claim 1 further comprising a wireless internet module connected to said central processing unit.

8. The on-demand video training and self analysis system of claim 7 wherein said central processing unit is capable of transmitting and receiving said digital information via said wireless internet module.

9. The on-demand video training and self analysis system of claim 1, wherein said central processing unit is capable of displaying advertisements on said monitor.

10. The on-demand video training and self analysis system of claim 1, wherein said central processing unit is capable of storing the digital information on removable storage media.

11. The on-demand video training and self analysis system of claim 1 further comprising a motion sensor linked to said central processing unit.

12. The on-demand video training and self analysis system of claim 1 further comprising an external trigger means linked to said central processing unit.

13. The on-demand video training and self analysis system of claim 1, wherein the system is portable.

14. The on-demand video training and self analysis system of claim 1, wherein a software application is stored in said central processing unit and said software application provides functionality of said user interface and displaying of said images on said monitor.

15. The on-demand video training and self analysis system of claim 1, wherein the system displays suggestions or advice based on a short questionnaire filled in by the user.

16. The on-demand video training and self analysis system of claim 1, further comprising a housing, wherein at least one of advertising banners, decals, messages, colors, text, graphics, logos, or slogans, is applied to the exterior surface of said housing unit.

17. The on-demand video training and self analysis system of claim 1, further comprising a housing, in the shape of a piece of athletic equipment.

18. The on-demand video training and self analysis system of claim 1 further comprising a timed interval of use for each user.
